(19) United States
(12) Patent Application Publication
(10) Pub. No.: US 2005/0046576 A1
(43) Pub. Date: Mar. 3, 2005

(54) Adjustable training system for athletics and physical rehabilitation including student unit and remote unit communicable therewith

(75) Inventors: Marcus F. Julian, Medford, MA (US); Christopher R. Noble, Winchester, MA (US); A. Rhys Thomas, Medfield, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Ultimate Balance, Inc.

(21) Appl. No.: 10/916,010

(22) Filed: Aug. 11, 2004

Related U.S. Application Data
(60) Provisional application No. 60/504,518, filed on Sep. 18, 2003.
(60) Provisional application No. 60/497,460, filed on Aug. 21, 2003.

(51) Int. Cl. G08B 23/00

(52) U.S. Cl. 340/573.1

(57) ABSTRACT

A system and method of monitoring the position of a body part of a user. The system may be employed in athletic training, physical rehabilitation, or maintenance of proper body balance in daily activities. The system essentially creates a learning environment in which an athlete or physiotherapy patient is taught via immediate verbal feedback the proper body position to maintain for a particular sport or activity. The system includes one or more motion-detecting/signal-emitting units (“student units”) and one or more monitor/control units (“pro units”). Each student unit is mountable on the student user, and a position sensor within the unit senses a direction/magnitude of tilt/rotation relative to a predetermined reference position. The user of the pro unit can remotely monitor the positional information generated by the student unit via a wireless communications interface, as the user engages in the particular sport or activity. The pro user can change selected operational modes of the student unit based on the monitored angular/rotational position information.

### CROSS REFERENCE TO RELATED APPLICATIONS

This application claims the priority of U.S. Provisional Patent Application No. 60/504,518 filed Sep. 18, 2003 entitled ADJUSTABLE TRAINING SYSTEM FOR ATHLETICS AND PHYSICAL REHABILITATION INCLUDING STUDENT UNIT AND REMOTE UNIT COMMUNICABLE THEREWITH, and U.S. Provisional Patent Application No. 60/497,460 filed Aug. 21, 2003 entitled ADJUSTABLE ATHLETIC TRAINING SYSTEM INCLUDING STUDENT UNITS AND A REMOTE UNIT COMMUNICABLE THEREWITH.

### STATEMENT REGARDING FEDERALLY SPONSORED RESEARCH OR DEVELOPMENT

N/A

### BACKGROUND OF THE INVENTION

The present application relates generally to the fields of athletic training and physical rehabilitation, and more specifically to systems and methods of monitoring body positions of athletes, physiotherapy patients, individuals suffering from balance problems, and other users of the system, and for effectively providing immediate feedback to the system user relating to the monitored body position for use in such training, rehabilitation, and maintenance of proper body balance in daily activities.

Athletic training systems are known that may be employed to monitor the body position and/or movement of an athlete as he or she engages in a particular sporting activity. Conventional athletic training systems monitor the body movements of an athlete as he or she swings a golf club, a baseball bat, a hockey stick, or a tennis racket. In the event the athletic training system detects a body motion that deviates from a desired motion for a particular sport, the system provides the athlete with a visible and/or audible indication of the undesirable body motion in real time. Alternatively, the athletic training system may store information relating to the athlete's body movement for review at a later time.

For example, U.S. Pat. No. 5,430,435 (the '435 patent) issued Jul. 4, 1995 entitled ADJUSTABLE ATHLETIC TRAINING SYSTEM discloses an athletic training system including a position processor that may be mounted on the headband of an athlete, or on any other suitable body part or article of clothing. The position processor includes one or more sensors operative to detect the direction of tilt of the athlete's head (e.g., left-to-right and/or front-to-back), to process data representative of the detected tilt direction for generating head position information, and to provide the athlete with visible and/or audible indications of the positional information in real time. Because the athletic training system described in the '435 patent provides body position information to an athlete in real time as he or she engages in a particular sporting activity, the training system essentially creates a learning environment in which the system teaches the athlete via immediate feedback the proper body position to maintain for the particular sport. The athletic training system therefore obviates the need for the athlete to engage in a protracted after-the-fact analysis of his or her athletic performance—the system essentially allows the athlete to learn while doing.

For example, while playing tennis, it is important that the tennis player's head be maintained in a proper “head-up” position, i.e., the axis of the head is maintained substantially vertical. When the tennis player's head is in the head-up position, the player's balance is improved, thereby making it easier for the player to track a rapidly moving tennis ball. If the head is not positioned in the proper head-up position, then the tennis player's performance typically deteriorates. By mounting the position processor described in the '435 patent on his or her headband, the tennis player can receive an immediate visual and/or audio indication of his or her head tilting away from the desired vertical axial position. As a result, the tennis player can learn to maintain his or her head in the proper head-up position while practicing or playing a tennis game or match.

Not only is it important for a tennis player to monitor the position of his or her head while playing tennis, but it is also important for certain patients receiving physical therapy in hospital or rehabilitation settings to monitor and to maintain proper head position. For example, victims of stroke often subconsciously tilt their heads to one side. By attaching the position processor described in the '435 patent to the head of a patient suffering from a stroke, the stroke patient can receive immediate indications of the times when his or her head tilts away from the vertical axial position, thereby enabling the patient to learn how to maintain proper head position while standing, sitting, or walking.

Although the athletic training system disclosed in the '435 patent has been successfully employed in many different athletic training and physical therapy applications, the system has potential drawbacks. For example, tilt indicators such as accelerometers often generate misleading signals when tilting is accompanied by rotation or translation. Further, it is often desirable to mount such training systems on different parts of the user's body for different applications and/or for aesthetic reasons, and to provide a way of determining the orientation of the system relative to the user. Moreover, some users of the system may be unable to recognize and to respond quickly and appropriately to the visible and/or audible indications provided by the position processor. In addition, visible and/or audible feedback may be inappropriate in certain environments such as public places or if the user is visually or audibly impaired.

Further, because different sports typically require athletes to perform different body movements and to assume different body positions, the system may provide visible and/or audible indications to athletes at inappropriate times, depending upon the type of sport being played. In addition, the user and/or a physical therapist may desire some quantitative feedback relating to the user's balance skill level. Moreover, some system users may not thrive in a “learn while doing” type of learning environment, and may require supplemental guidance or instruction from a human trainer or therapist. However, the athletic training system described in the '435 patent does not provide mechanisms for easily integrating monitoring and feedback functions performed by both the system and a human trainer/therapist, and for addressing the other limitations outlined above.

In addition, some physiotherapy patients may subconsciously make body movements that deviate from head or body tilting. For example, instead of merely tilting their heads, victims of stroke may also rotate their heads in the horizontal plane toward the side of their bodies most affected by the stroke. However, the system described in the '435 patent is typically not suited for monitoring or for providing indications of such rotational head movements.

It would therefore be desirable to have an improved system and method of monitoring body position for use in athletic training, physical rehabilitation, and the performance of daily activities that avoid the drawbacks of the above-described systems.

### BRIEF SUMMARY OF THE INVENTION

In accordance with the present invention, a system and method of monitoring the body position of a user are provided that may be employed in athletic training and physical rehabilitation applications. The presently disclosed body position monitoring system essentially creates a learning environment in which an athlete or physiotherapy patient is taught via immediate feedback the proper body position to maintain for a particular sport or activity. The system effectively teaches the athlete or patient to maintain proper body position as he or she participates in a sport, or while simply standing, sitting, or walking. In this way, the presently disclosed body position monitoring system allows the user to learn while doing. The presently disclosed system also teaches the user to compensate for physiological and/or neurological defects that may impair proper balance while performing daily activities.

In one embodiment, the body position monitoring system comprises one or more motion-detecting/signal-emitting units (“student units” or “local units”) and one or more monitor/control units (“professional units”, “pro units”, or “remote units”). Each one of the student and pro units includes at least one processor and associated program/data memory; a voice processor, an audio amplifier, and a speaker for providing verbal feedback to the user; an input mechanism such as a switch pad for turning the unit on and off, for selecting desired operating modes and parameters, and for calibrating the system; a data communications interface for connecting the unit to a network or personal computer; and, a wireless communications interface for communicably coupling the unit to one or more remote units via a selected radio frequency (RF) channel. Each student unit further includes at least one position sensor operative to sense a direction and a magnitude of angular and/or rotational displacement of a selected body part of the user. In an alternative embodiment, the student unit may be employed as a standalone unit.

In one mode of operation, each student unit is mountable directly or indirectly on a selected body part of the user, and the position sensor within the student unit is operative to sense a direction and a magnitude of tilt of the selected body part relative to a predetermined reference position. Further, the processor within the student unit is operative to convert data representing the tilt direction/magnitude into angular position information, to determine a length of time the selected body part is positioned at the angular position, and to provide selected verbal feedback to the user based on the angular position information and/or the length of time the body part is positioned at that angular position. According to one feature, the position sensor is further operative to sense a direction and a magnitude of rotation of the selected body part in a predetermined plane, and the processor is further operative to provide selected verbal feedback to the user based on the rotational position information.

According to another feature, the data memory within the student unit is operative to store one or more customizable voice data files. Each voice data file is customizable to represent a respective spoken word or phrase such as “tilting left”, “tilting right”, “tilting forward”, “tilting backward”, “rotating right”, “rotating left”, “keep head up”, and/or any other suitable word or phrase. The voice processor is operative to process the word/phrase data to allow an audible indication of the word/phrase to be provided to the user via the audio amplifier and speaker. Further, each voice data file is customizable to reproduce the sound of the user's voice, or the voice of a selected individual other than the user such as a teacher or sports celebrity. Moreover, each voice data file is customizable to allow verbal feedback to be provided to the user in one or more different languages selectable by the user. In addition, each voice data file is loadable into the data memory via the data communications interface or the wireless communications interface.

According to still another feature, the student unit is operative to perform analog or digital filtering on the data representing the tilt direction/magnitude, and on the data representing the rotational direction/magnitude, thereby removing spurious artifacts from the tilt/rotation data that may affect the accuracy of the associated angular/rotational position information. Further, the type of filtering performed by the processor is selectable based on the sport or other activity currently engaged in by the user.

In another mode of operation, a user of the pro unit such as a human athletic trainer or physical therapist can remotely monitor the angular/rotational position information generated by the student unit via the wireless communications interfaces of the respective units, as the user engages in the particular sport or activity. Further, the trainer or therapist can change the selected operational mode, the selected type of filtering, and/or any other selected operational parameter(s) of the student unit via the switch pad of the pro unit and the respective wireless communications interfaces, based on the monitored angular/rotational position information and the particular sport or activity engaged in by the athlete or patient. Moreover, the trainer or therapist can remotely disable the verbal feedback provided to the user by the student unit via the switch pad of the pro unit, in event the user becomes unduly distracted by the audible feedback while engaging in the particular sport or activity.

By providing a body position monitoring system including multiple programmable student and pro units, in which each student unit provides immediate verbal feedback to a user of the student unit based on the angular/rotational position of the user's body, and in which each pro unit provides the capability of remotely monitoring the positional information and of optionally changing the operational modes and parameters of the student unit based on the positional information and the particular activity currently engaged in by the student user, a learning environment can be created and tailored to satisfy the particular athletic training or physical therapy needs of the athlete or physiotherapy patient.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the Drawings of which:

FIG. 1 is a block diagram of a body position monitoring system including a pro unit and a plurality of student units according to the present invention;

FIG. 2 is a block diagram of one of the student units included in the system of FIG. 1;

FIG. 3 is a diagram illustrating the operational modes of the student unit of FIG. 2;

FIG. 4 is an illustration of an exemplary use of the student unit of FIG. 2, in which the student unit is mounted on the headband of an athlete;

FIGS. 5a-5c are illustrations of multiple views of the student unit of FIG. 2;

FIG. 6 is a diagram illustrating accelerometer output versus angular tilt of the student unit of FIG. 2;

FIG. 7 is a first diagram illustrating the effect of accelerometer noise versus angular tilt of the student unit of FIG. 2;

FIG. 8 is a second diagram illustrating the effect of accelerometer noise versus angular tilt of the student unit of FIG. 2;

FIG. 9 is a diagram of the respective responses of a 15-tap FIR filter, a running average filter, and a single pole filter, each of which may be employed in the student unit of FIG. 2; and

FIG. 10 is a flow diagram of a method of calibrating the student unit of FIG. 2.

### DETAILED DESCRIPTION OF THE INVENTION

U.S. Provisional Patent Application No. 60/504,518 filed Sep. 18, 2003 entitled ADJUSTABLE TRAINING SYSTEM FOR ATHLETICS AND PHYSICAL REHABILITATION INCLUDING STUDENT UNIT AND REMOTE UNIT COMMUNICABLE THEREWITH, and U.S. Provisional Patent Application No. 60/497,460 filed Aug. 21, 2003 entitled ADJUSTABLE ATHLETIC TRAINING SYSTEM INCLUDING STUDENT UNITS AND A REMOTE UNIT COMMUNICABLE THEREWITH, are incorporated herein by reference.

A body position monitoring system and method are disclosed that may be employed to create a learning environment for users such as athletes and physiotherapy patients, or as an aid in maintaining proper balance during the performance of daily activities. The presently disclosed monitoring system provides verbal feedback to system users in real time based on the angular and/or rotational positions of a body part to which the system is attached, while allowing information relating to the position of the user's body part to be remotely monitored. The verbal feedback and associated body position information generated by the system may be used by athletes to help them learn desired body positions for a particular sporting activity such as tennis, golf, fencing, sculling, dance, or any other suitable sporting or leisure activity. The verbal feedback and body position information may also be used by physiotherapy patients as aids in learning proper body control, or to palliate the acute or chronic effects of a loss of self control, which may have occurred due to an accident, age-related degradation, or illness. The system further allows operating modes and parameters of the system to be changed either remotely or locally to create a learning or long-term usage environment that best suits each system user.

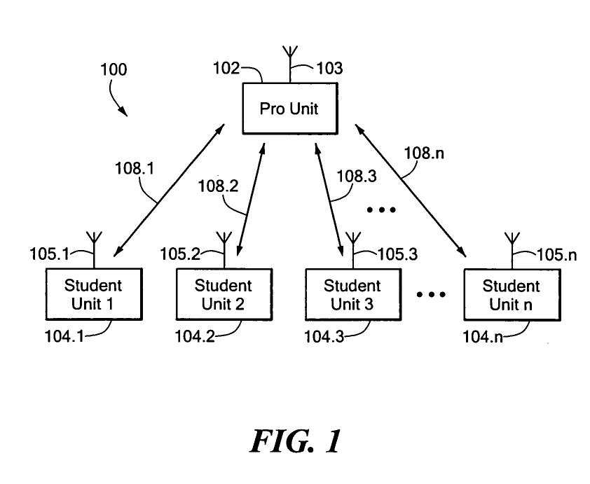

FIG. 1 depicts an illustrative embodiment of a body position monitoring system 100, in accordance with the present invention. In the illustrated embodiment, the body position monitoring system 100 comprises at least one pro unit 102, and a plurality of student units 104.1-104.n. As described in detail below, each one of the student units 104.1-104.n is mountable on or otherwise attachable to a selected body part (e.g., head or chest) of a user of the system (i.e., a “student user” or “student” such as an athlete or physiotherapy patient), or on a selected article of the student's clothing (e.g., hat or jersey). Further, each student unit 104.1-104.n is operative to sense the student's body position relative to a predetermined reference position, and to provide audible feedback to the student based on the sensed body position. For example, the audible feedback may comprise selected words, phrases, sounds, and/or tones. In alternative embodiments, the student unit may be configured to vibrate in response to the sensed body position. In addition, each pro unit 102 is operative to remotely monitor information relating to the body positions of the student users, as sensed by the student units 104.1-104.n. Further, a user of the pro unit 102 (i.e., a “professional user” or “professional” such as an athletic trainer or physical therapist) can remotely change operational modes and/or parameters of selected ones of the student units 104.1-104.n via the pro unit 102. The student users can also change the operational modes and/or parameters of the student units 104.1-104.n locally. In this way, a desired learning environment can be created for each athlete and/or physiotherapy patient.

As shown in FIG. 1, the pro unit 102 includes an antenna 103, and each one of the student units 104.1-104.n includes a respective antenna 105.1-105.n. In the presently disclosed embodiment, the student units 104.1-104.n employ their respective antennas 105.1-105.n to transmit data representing verbal feedback and/or positional information to the pro unit 102, and to receive control information relating to operational mode and parameter selections from the pro unit 102, over respective wireless communications channels such as radio frequency (RF) channels 108.1-108.n. Similarly, the pro unit 102 employs its antenna 103 to receive the data representing the verbal feedback and/or the positional information from the student units 104.1-104.n, and to transmit the operational mode and parameter selections to the student units 104.1-104.n, over the respective RF channels 108.1-108.n.

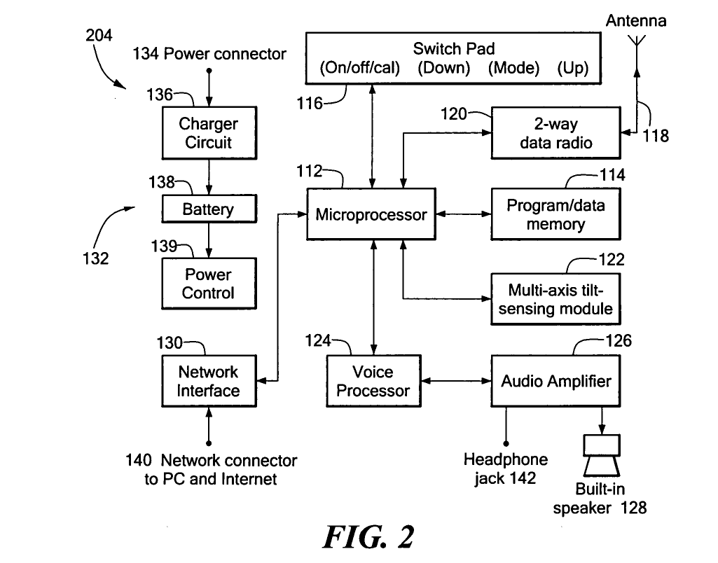

FIG. 2 depicts an illustrative embodiment 204 of one of the pro and student units 102, 104.1-104.n (see FIG. 1). In the illustrated embodiment, the unit 204 comprises a position processor such as a microprocessor 112, a program/data memory 114 (e.g., ROM and/or RAM), a switch pad 116, a two-way data radio 120, an antenna 118, a position sensor such as a multi-axis tilt/rotation sensing module 122, a voice processor 124, an audio amplifier 126 and associated headphone jack 142 and speaker 128, a network interface 130 and an associated network connector 140, and a power source 132 including an associated power connector 134, a battery charger 136, a battery 138, and a power control unit 139. It is understood that each one of the student units 104.1-104.n (see FIG. 1) is like the unit 204, as depicted in FIG. 2. It is further noted that the pro unit 102 (see FIG. 1) is like the unit 204 of FIG. 2. It should therefore be appreciated that the unit 204 depicted in FIG. 2 may correspond to either a student unit 104 or a pro unit 102.

In the presently disclosed embodiment, the unit 204 (see FIG. 2) is configurable to operate in multiple modes including a “student mode”, a “standalone mode”, and a “pro mode”. In the student mode, the unit 204 operates as a student unit, and may be controlled remotely by a pro unit via the two-way data radio 120 and the antenna 118. The unit 204 may also provide verbal feedback and/or positional information to the pro unit via the two-way data radio 120 and the antenna 118. In the standalone mode, the unit 204 again operates as a student unit, however, it is not controllable by the pro unit. The two-way data radio 120 and the antenna 118 may therefore be excluded from the unit 204, in the event the unit is specifically configured for operation only in the standalone mode. In the pro mode, the unit 204 operates as a pro unit, and may monitor and/or control selected student units via the two-way data radio 120 and the antenna 118 over corresponding RF channels 108.1-108.n. In the event the unit is specifically configured for operation in the pro mode, the multi-axis tilt/rotation sensing module 122 may be excluded from the unit 204.

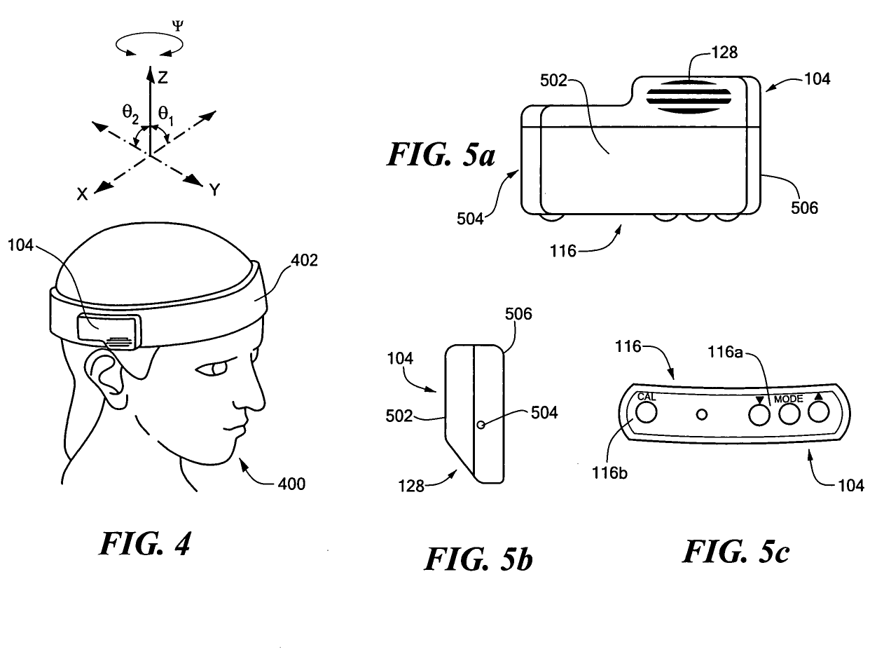

The multi-axis tilt/rotation sensing module 122 may comprise one or more mechanical switches, one or more multi-axis accelerometers and/or gyroscopes, or any other suitable mechanism(s) for sensing a direction and a magnitude of angular and/or rotational displacement of the unit 204 in one, two, or three-dimensional space relative to at least one predetermined reference position. In one embodiment, the multi-axis tilt/rotation sensing module 122 comprises a low-cost multi-position mercury switch, as described in U.S. Pat. No. 5,430,435 issued Jul. 4, 1995 entitled ADJUSTABLE ATHLETIC TRAINING SYSTEM, which is incorporated herein by reference. The mercury switch includes a mercury droplet that contacts pins of the switch if the sensing module 122 is tilted from a substantially horizontal position in any direction. The number of pins simultaneously contacted by the mercury droplet varies with the relative angle of tilt of the sensing module 122. For example, if the unit 204 is mounted on the headband of a tennis player (see, e.g., FIG. 4 depicting a student unit 104 mounted on a headband 402 of a tennis player 400), then the sensing module 122 including the mercury switch is operative to sense the tennis player's head tilting left or right in the X-Z plane, and to sense the player's head tilting forward or backward in the Y-Z plane. In another embodiment, the multi-axis tilt/rotation sensing module 122 comprises at least one dual axis MEMS accelerometer configured to sense the change in apparent gravity corresponding to a tilt angle θ of the unit 204 relative to the two orthogonal axes X-Z or Y-Z (see FIG. 4). In still another embodiment, the sensing module 122 or the microprocessor software is operative to disable/enable one or more directions of tilt and/or rotation sensing based on the sport or other activity engaged in by the user. For example, when a rower is performing a stroking action, it may be necessary to monitor only the left and right tilting of the rower's head. In this case, the sensing module 122 or the microprocessor software may be enabled to sense tilting in the left and right directions, while disabling sensing in the front and backward directions. For example, the sensing module 122 may include an ADXL202 Dual Axis Accelerometer sold by Analog Devices Inc., Norwood, Mass., U.S.A., or an MXD2020GL Dual Axis Accelerometer sold by MEMSIC Inc., North Andover, Mass., U.S.A. In still another embodiment, the multi-axis tilt/rotation-sensing module 122 comprises at least one gyroscope configured to sense the clockwise/counter clockwise rotation φ of the unit 204 in the horizontal plane X-Y (see FIG. 4).

For example, when the unit 204 is mounted on the headband 402 of the tennis player 400 (see, e.g., FIG. 4), the student unit including the sensing module 122 may be positioned just behind the tennis player's ears to allow it to rotate in a substantially circular path about the vertical axis Z, which conceptually passes through the player's head in the desired “head-up” position. Such positioning of the student unit relative to the tennis player's head makes it easier for the sensing module 122 to discriminate between rotational and lateral movements of the player's body. In the preferred embodiment, the multi-axis tilt/rotation-sensing module 122 includes at least one accelerometer and at least one gyroscope configured to allow the sensing module 122 to sense tilting and/or rotation of a selected part of the user's body.

It is appreciated that in alternative embodiments, the student unit may be mounted on any suitable body part (e.g., head or chest) or on any suitable article of clothing (e.g., hat or jersey) of the user to sense the tilting or rotation of the user's body in a given vertical or horizontal plane. For example, the student unit including the multi-axis tilt/rotation sensing module 122 may be mounted on the chest or jersey of a physiotherapy patient for directly sensing and monitoring truncal stability.

In the presently disclosed embodiment, when the unit 204 (see FIG. 2) operates as a student unit, the local communication sub-system including the microprocessor 112, the program/data memory 114, the voice processor 124, the audio amplifier 126, and the speaker 128 functions as a digital audio play-only sub-system. In this illustrative embodiment, the data memory 114 is operative to store one or more voice data files, in which each voice data file is customizable to represent a respective spoken word or phrase such as “tilting left”, “tilting right”, “tilting forward”, “tilting backward”, “rotating right”, “rotating left”, “tilting front-right”, “tilting front-left”, “tilting back-right”, “tilting back-left”, “keep head up”, and/or any other suitable word or phrase. In the preferred embodiment, the words and phrases are stored in the data memory 114 in a suitable encoded data format.

Accordingly, in response to the angular and/or rotational position information provided to the microprocessor 112 by the sensing module 122, the microprocessor 112 may access one or more data files containing data representative of a suitable word(s) or phrase(s) from the data memory 114, and then decompress the word or phrase data and provide it to the voice processor 124. Next, the voice processor 124 processes the digital word or phrase data to generate an analog voice signal representing the word or phrase, and provides the voice signal to the audio amplifier 126 for subsequent reproduction of the word or phrase via the speaker 128, or via an ear plug or headphones connected to the headphone jack 142. In alternative embodiments, the words and phrases may be stored in the data memory 114 in an uncompressed data format. Further, the local communication sub-system of the student unit may alternatively comprise an analog audio sub-system operative to play and record words, phrases, and/or any other suitable sounds in analog form.

As described above, when operating in the student mode, the unit 204 (see FIG. 2) may be controlled remotely by a pro unit. Further, when operating in the pro mode, the unit 204 may be used for remotely controlling one or more student units. Such remote control is achieved via the two-way data radio 120 and the antenna 118 over a selected one(s) of the RF channels 108.1-108.n (see FIG. 1). In the presently disclosed embodiment, the two-way data radio 120 comprises an RF transceiver configured to provide digital simplex, half duplex, or full duplex communications with another RF transceiver tuned to the same radio frequency. For example, the pro unit 102 (see FIG. 1) may include the two-way data radio 120 comprising an RF transceiver capable of transmitting and receiving digital data in the 433 MHz ISM RF band, or any other suitable RF frequency band. In addition, the student units 104.1-104.n may include respective RF transceivers capable of transmitting and receiving over a plurality of non-interfering frequencies within the 433 MHz ISM band, or any other suitable RF band. It is noted that the transmit and receive frequencies of the student units 104.1-104.n may be changed locally by the student users, or remotely by the user of the pro unit. In alternative embodiments, the RF transceiver of the two-way data radio 120 may be configured to provide analog simplex, half duplex, or full duplex data transmission in any suitable RF band(s), or in any suitable visible, near visible, or invisible optical frequency band(s). In the preferred embodiment, the RF transceiver included in the two-way data radio 120 is implemented using a CC1000 RF Transceiver for the 433 MHz band, which is sold by Chipcon AS, Oslo, Norway.

In the presently disclosed embodiment, the switch pad 116 included in the unit 204 (see FIG. 2) has four tactile momentary pushbuttons, i.e., on/off/cal, mode select (“Mode”), scroll down (“Down”), and scroll up (“Up”). Specifically, depressing the on/off/cal pushbutton for a short time causes the unit 204 to perform a calibration routine, as described below. Depressing the on/off/cal pushbutton for a longer time causes the unit 204 to power-up or power-down. The Mode, Down, and Up pushbuttons may be used to change the operating modes of the unit 204, as described below. In the preferred embodiment, the unit 204 provides audible feedback to indicate to the user which pushbutton he or she has pressed, and what operation is being performed in response to pressing the pushbutton, without requiring the user to look at the unit. The unit 204 may also include a display (not shown) including one or more lights, single or dual color LEDs, or any other suitable indicator for visually conveying information relating to system status and/or operation. Moreover, the network interface 130 may include an asynchronous RS-232 interface, a serial synchronous 3-wire interface, and/or any other suitable digital communications interface. As shown in FIG. 2, the network connector 140 may be employed to connect the network interface 130 to a computer such as a PC, or to a local or wide area network such as the Internet, via a suitable connector 140 (see FIG. 1).

As described above, when operating as a pro unit, the unit 204 (see FIG. 2) may monitor and/or control selected ones of the student units via the two-way data radio 120 and the antenna 118 over corresponding RF channels 108.1-108.n (see also FIG. 1). The local communication sub-system of the pro unit including the microprocessor 112, the program/data memory 114, the voice processor 124, the audio amplifier 126, and the speaker 128 is operative to reproduce the monitored verbal feedback and/or other sounds/alarms received from one or more of the student units via the two-way radio 120. Further, the display (not shown) including the lights, the LEDs, and/or other suitable indicators may be employed for visibly indicating the respective statuses of the pro and student units. In the presently disclosed embodiment, the two-way radio 120 is operative to receive and to transmit a plurality of frequencies using a time-division multiplexing technique. In alternative embodiments, the two-way radio 120 may use a spread spectrum multiplexing technique, a frequency division multiplexing technique, or any other suitable communications technique for simultaneously communicating with the plurality of student units 104.1-104.n (see FIG. 1).

In the presently disclosed embodiment, when the unit 204 (see FIG. 2) operates as a pro unit, the local communication sub-system including the microprocessor 112, the program/data memory 114, the voice processor 124, the audio amplifier 126, and the speaker 128 functions as a digital audio record-and-playback sub-system for playing and recording the words and/or phrases stored in the voice data files. For example, the digital audio data stored in the voice data files may be provided to the data memory 114 via the network interface 130 and the microprocessor 112. In alternative embodiments, the unit 204 may be configured to store analog audio data, which may be provided to suitable analog data storage media via a microphone input (not shown).

Because the angular and/or rotational position information provided to the microprocessor 112 by the multi-axis tilt/rotation sensing module 122 may include spurious artifacts affecting the accuracy of the angular/rotational position information, the microprocessor 112 is operative to process the positional data to remove such spurious artifacts. Further, the type of processing performed by the microprocessor 112 may be selected based on the sport or other activity currently engaged in by the user.

Specifically, in the event the multi-axis tilt/rotation sensing module 122 comprises a dual axis accelerometer, the sensing module 122 is operative to measure the relative acceleration due to gravity, depending upon the angle at which each accelerometer axis is positioned relative to the ground. Because the dual axis accelerometer may also respond to the acceleration generated by the user, e.g., an athlete, as he or she performs the normal lateral movements for his or her particular sport, the microprocessor 112 processes the raw accelerometer data provided by the sensing module 122 so that tilts of the athlete's body with respect to a predetermined reference position can be differentiated from the athlete's normal and expected lateral motions, or rotational motions in another plane.

In the preferred embodiment, the bandwidth (BW) of the dual axis accelerometer is set using a bypass capacitor for each accelerometer axis. For example, when a 0.47 μF bypass capacitor is used for each axis, the accelerometer bandwidth is about 10 Hz. As a result, the minimum rate at which the microprocessor 112 can sample each axis is about 20 Hz to prevent aliasing. It is noted that the dual axis accelerometer typically provides a respective pulse width modulated (PWM) digital signal for each accelerometer axis. Further, the maximum rate at which the microprocessor 112 can sample the PWM signals is limited by the performance capabilities of the microprocessor 112. In the presently disclosed embodiment, the microprocessor 112 employs a sampling rate of about 29 Hz.

The sampling rate of the microprocessor 112 may be determined as follows. Independent of the accelerometer bandwidth, the rate at which samples are detected by the microprocessor 112 is defined by the period (T2) of the PWM signals. For example, the period T2 of each PWM signal may be about 2.16 msec, which corresponds to a frequency of about 463 Hz. In the presently disclosed embodiment, the microprocessor 112 is configured to capture every 16^{th} sample of the accelerometer data for each axis, thereby providing the exemplary sampling rate of about 29 Hz.

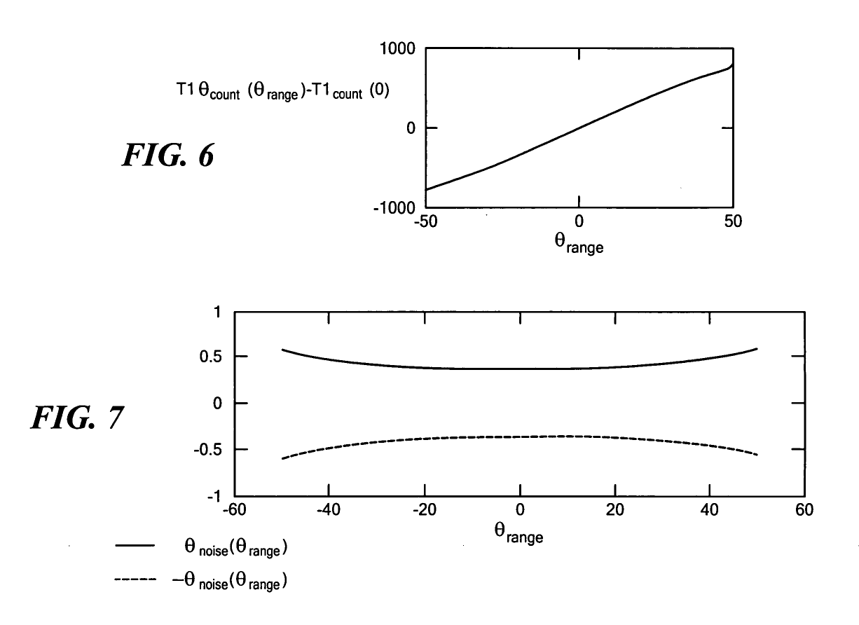

As indicated above, the period of the PWM signals generated by the dual axis accelerometer is designated as T2. If the time during which the PWM signal is active (e.g., logical high) is designated as T1, then the ratio of the values T1/T2 is proportional to the acceleration (g) sensed by the accelerometer along a respective axis. In the presently disclosed embodiment, the microprocessor 112 includes at least one timer configured to measure the T1 value for each accelerometer axis, in which the measured T1 values are expressed in terms of timer counts. For example, the measured T1 values may be expressed as
T1θ_{count}(θ)=T1_{count}(sin(θ(2π/360))), (1)
in which “θ” is the tilt angle relative to the predetermined reference position. Using equation (1), the T1 count difference from a nominal 0 degree tilt can be illustrated graphically, as depicted in FIG. 6.

It is noted that the accuracy of the angular/rotational position information provided by the sensing module 122 to the microprocessor 112 may also be affected by accelerometer noise. Accelerometer root mean square (rms) noise may be expressed as
Accelₙₒᵢₛₑᵣₘₛ(BW)=200(μg/Hz^{1/2})(BW*1.6)^{1/2}, (2)
in which “BW” is the accelerometer bandwidth. For example, if BW is 10 Hz, then Accelₙₒᵢₛₑᵣₘₛ(BW) equals 800 μg. The statistical probability that the accelerometer noise will exceed a predetermined peak value within a given time may be calculated as follows. For Gaussian noise, the statistical probability that the noise exceeds the rms value may be expressed as
fₛₐₘₚₗₑ=10 Hz, (3)
rms8_{percent}=0.006, rms6_{percent}=0.27, (4)
in which “rms8_{percent}” and “rms6_{percent}” represent the percentage of samples occurring at 8×(rms value) and 6×(rms value). Accounting for the sampling rate, the time between false samples due to the noise may be expressed as
T_{false}(rms_{percent})=100/(rms_{percent}*fₛₐₘₚₗₑ). (5)

Accordingly, T_{false}(rms8_{percent}) equals about 9.579 minutes. To assure that false samples due to accelerometer noise occur at a rate of no more than 1 every 10 minutes, the resolution of the system is limited by a noise peak of about eight times the accelerometer noise specification. The noise peak (rms) may be expressed as
Accelₙₒᵢₛₑₚₑₐₖ=Accelₙₒᵢₛₑᵣₘₛ(BW)*8, (6)
Accelₙₒᵢₛₑₚₑₐₖ=6.4×10⁻³ g. (7)
The effect of this accelerometer noise as a function of tilt angle θ can be determined by expressing the tilt angle in terms of acceleration, and then defining the incremental accelerometer gain (d_{angle}/d_{g}) at a given tilt angle θ. The noise peak is then multiplied by the accelerometer incremental gain, as a function of the tilt angle θ range, to obtain the angular error θₙₒᵢₛₑ due to the accelerometer noise, as depicted in FIG. 7.

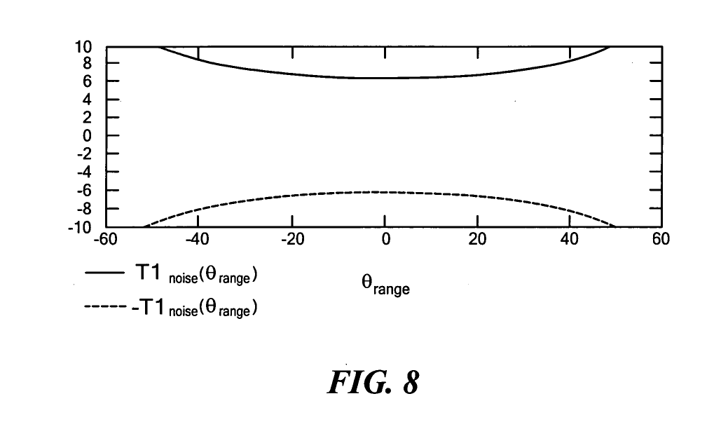

FIG. 8 depicts the T1_{count} error due to accelerometer noise, which is statistically summed every 10 minutes, as a function of the tilt angle θ range. As shown in FIG. 8, the accelerometer gain increases at the tilt extremes, indicating an increase in the susceptibility to noise. Accordingly, in the presently disclosed embodiment, the system is limited to ±10 counts of resolution. To enhance the processing speed, the T1_{count} may be limited to an 8 bit value (byte). This can be done by appropriately shifting the T1_{count} value for larger counts so that the result is always 8 bits. Although this may cause the system to have reduced resolution for larger tilt angles, the system performance is typically not adversely affected because such larger tilt angles generally correspond to extreme user movements.

In the presently disclosed embodiment, the microprocessor 112 is operative to increment a counter when the tilt angle θ exceeds a predetermined threshold level corresponding to a selected sensitivity level for the sensing module 122, as described below. Specifically, the counter output is compared to a predetermined delay value, which is set by the sensitivity level. Counter values that exceed the delay value cause an alarm output to be generated, which may be conveyed to the user locally via audible words, sounds, or tones, and/or remotely via one of the RF channels. Any single tilt angle sample value below the predetermined threshold level resets the counter to zero, at which point counting begins again.

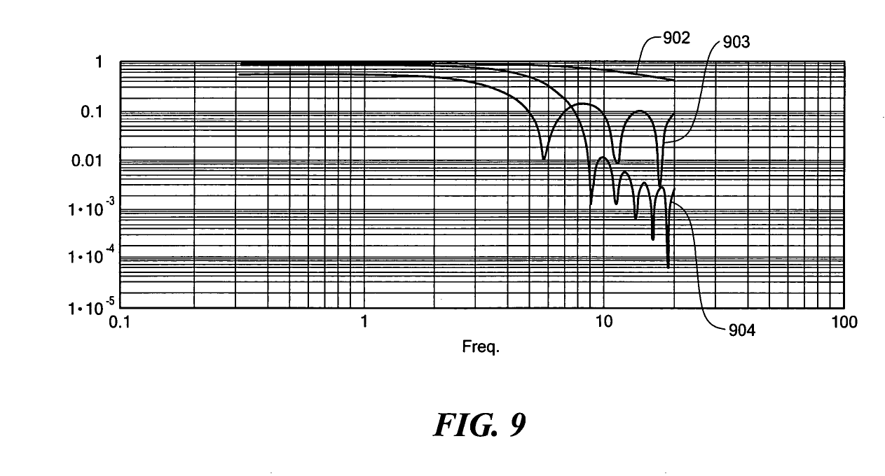

The microprocessor 112 is also operative to filter the tilt angle θ values before determining whether or not to increment the counter, thereby further removing spurious artifacts that might reduce the accuracy of the system. For example, the microprocessor 112 may filter the tilt values using a finite impulse response (FIR) filter, a running average filter, a low pass filter characterized by a suitable number of poles, or any other suitable digital or analog filter. FIG. 9 depicts the responses of three representative filters, namely, a 15-tap FIR filter 904, a running average filter 903, and a single pole low pass filter 902.

In one embodiment, in order to improve the system's ability to discriminate between user motions of interest and insignificant user motions such as quick jerking movements and/or very slow movements, the microprocessor 112 is operative to filter the angular and/or rotational position information provided by the sensing module 122 using frequency-based signal processing. Such user motions of interest (i.e., tilting or rotational motions) typically fall within a specific range of frequencies. The microprocessor 112 is operative to filter the positional information using low pass, high pass, or band-pass filtering to remove frequencies above and/or below a predetermined frequency range, which may vary depending on the sport or other activity engaged in by the user. The characteristics of the filtering performed via the microprocessor 112 may also depend on other factors including the user's skill level and the size/shape of the user's body. In the preferred embodiment, the microprocessor 112 and its associated program/data memory 114 are programmable to allow the user to download one or more filtering algorithms, and to select the most appropriate pre-programmed filtering algorithm to use based on the user's body characteristics, sport, or other activity.

For example, the network connector 140 may be employed to connect the network interface 130 to a personal computer and/or the Internet to download to the program/data memory 114 selected filtering algorithms for various sports and/or physical therapies, to modify programs based on user requirements or on analyses of previous user performances, to download voice data files containing words and/or phrases appropriate for the specific application in a variety of different languages (e.g., English, French, German, Italian, Chinese, Japanese, Korean, etc.), and to download data files containing different types of sounds and/or tones. In one embodiment, the voice data files downloaded to the program/data memory 114 are customized to reproduce the sound of the user's voice or the voice of a selected individual other than the user such as a teacher or a sports celebrity. The network connector 140 and the network interface 130 may also be employed to upload filtering algorithms, voice data files, and/or other program/data files to a personal computer or the Internet to allow users to share program and data software.

In another embodiment, the microprocessor 112 is operative to filter the angular and/or rotational position information provided by the sensing module 122 using time-based signal processing. Specifically, the microprocessor 112 is operative to measure the length of time that a body part of the user is positioned at a particular position. For example, the microprocessor 112 may measure the length of time that the user's body part is tilted beyond a predetermined tilt angle threshold. The microprocessor 112 is further operative to determine whether or not to trigger the audible feedback based on the measured time interval. In this way, the system is better able to discriminate between user motions of interest and insignificant user movements.

In the preferred embodiment, the microprocessor 112 and the program/data memory 114 (see FIG. 2) are implemented using a PIC18F252 micro-controller sold by Microchip Technology Inc., Chandler, Ariz., U.S.A., with 32K of on-chip FLASH memory, 1536 bytes of RAM, and 256 bytes of EEPROM. The EEPROM is configured to store the operating mode and parameter settings of the student and pro units when the respective units are in a power-down state. In alternative embodiments, the microprocessor 112 and the program/data memory 114 may be implemented using a Microchip PIC18F242 micro-controller, a Microchip PIC18C242 micro-controller, an Intel 8051 micro-controller, or any other suitable standard or custom, programmable or dedicated processor and associated program/data memory.

As described above, the unit 204 (see FIG. 2) includes the power source 132 including the power connector 134, the battery charger 136, the battery 138, and the power control unit 139. For example, the battery 138 may comprise a 750 mA/hour lithium ion battery, or any other suitable re-chargeable or replaceable battery. The power control unit 139 is configured to monitor the charge on the battery 138 by tracking the battery voltage level. In the event the battery voltage falls below a predetermined voltage level, the system notifies the user of the low-battery condition via an audible feedback, a visual indication such as an activated LED, or any other suitable indicator or alarm. The battery charger circuit 136 comprises a constant voltage, constant current charger circuit. For example, the battery charger circuit 136 may be implemented using an LTC1734ES6 Li-Ion Linear Charger sold by Linear Technology Corporation, Milpitas, Calif., U.S.A., or any other suitable charger circuit. In a typical mode of operation, the battery 138 may be charged by connecting a standard 5-6 VDC battery charger supplying at least 500 mA to the power connector 134.

FIG. 4 depicts the student unit 104 mounted on the headband 402 of a student user such as the tennis player 400. For example, the student unit 104 may be mounted on or otherwise attached to the headband 402 by Velcro, by any suitable adhesive, or by hooks, snaps, or any other suitable mechanical fasteners. FIGS. 5a-5c depict respective views of the student unit 104 illustrated in FIG. 4. Specifically, FIG. 5a depicts the side of the student unit 104 that is disposed against the headband 402 of the tennis player 400. As shown in FIG. 5a, the side of the student unit 104 disposed against the headband 402 has a Velcro surface 502. It is understood that a cooperating section of Velcro is disposed on the headband 402 to enable the unit 104 to be securely mounted thereon. The student unit 104 includes a housing 506 preferably made of high impact plastic, in which openings are formed in registration with the built-in speaker 128.

As shown in FIGS. 5a-5b, the speaker 128 is suitably angled in the direction of the tennis player's ear (see also FIG. 4) to enhance the player's ability to hear the audible feedback provided by the unit 104. This obviates the need for the tennis player 400 to use an ear plug or headphones, which may be coupled to the jack 142 (see FIG. 2) via a hole 504 in the unit housing 506. Because in some instances the student unit 104 may be shared among multiple student users, hygienic concerns are alleviated by not having to use the ear plug. It is noted, however, that the ear plug may be favored by some physiotherapy patients who may use the student unit 104 everyday to address chronic balance problems.

FIG. 5c depicts the four tactile momentary pushbuttons included in the switch pad 116 of the student unit 104 (see also FIG. 2). As shown in FIG. 5c, the four pushbuttons include a group of pushbuttons 116a including the mode select (“Mode”) pushbutton, the scroll down (“Down”) pushbutton, and the scroll up (“Up”) pushbutton. The four pushbuttons further include a pushbutton 116b, which is the on/off/cal pushbutton. The use of these four pushbuttons of the switch pad 116 is described in detail below.

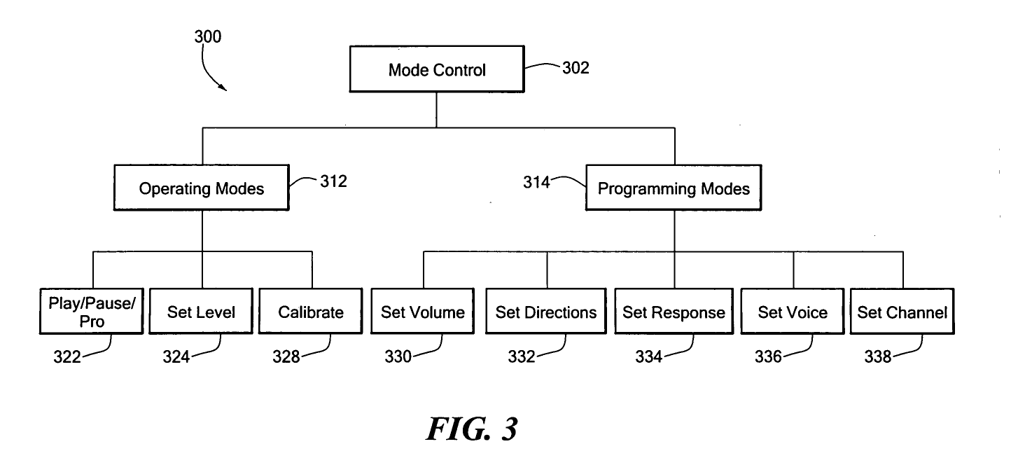

It was described that the operational modes and/or parameters of the student units 104.1-104.n (see FIG. 1) may be changed remotely via the pro unit 102, or may be changed locally using the switch pad 116 of the student unit 104, to create a desired learning environment for the student user. It is noted that the operational modes/parameters of the pro unit 102 may also be changed locally via the switch pad 116. FIG. 3 depicts the operating and programming modes 300 of the pro and student units 102, 104.1-104.n. In the presently disclosed embodiment, the local operating and programming mode settings can be changed by simultaneously depressing the Mode pushbutton and either the Down pushbutton or the Up pushbutton of the switch pad 116 to scroll or cycle through the available mode and parameter selections, which are audibly indicated to the user via the speaker 128, the ear plug, or the headphones.

With reference to FIG. 3, the student or pro user locally accesses a mode control function 302 of the student or pro unit via the Mode, Down, and Up pushbuttons 116a of the switch pad 116 (see also FIG. 2). For example, the user may depress the Mode pushbutton for a short time to access a plurality of operating modes 312, or may depress the Mode pushbutton for a longer time to access a plurality of programming modes 314. In the event the user accesses the operating modes 312, the user may then simultaneously depress the Mode pushbutton and the Down or Up pushbutton to cycle through and to select the following operating modes: Play/Pause/Pro 322, Set level 324, and Calibrate 328.

Within the Play/Pause/Pro 322 operating mode, the user selects one of the Play, Pause, and Pro operating sub-modes. In the presently disclosed embodiment, the Play mode allows the student or pro unit to provide audible feedback to the user via the speaker, the ear plug, or the headphones. In the Pause mode, the unit is activated but provides no audible feedback to the user. This mode is particularly useful when the user is temporarily involved in an activity unrelated to the sport or other activity currently being engaged in. For example, the student user may be picking up tennis balls or speaking with the tennis pro. A transition from the Pause mode to the Play mode is accomplished by a short depression of the Mode pushbutton. In the Play mode, the user may adjust the sensitivity settings of the unit using the Up and Down pushbuttons. In the preferred embodiment, each sensitivity setting has a corresponding tilt angle threshold level, a corresponding filtering algorithm for discriminating between tilting and lateral user motions, and a corresponding maximum time for the user's body to remain beyond the tilt angle threshold. By selecting an appropriate sensitivity setting, the user can tailor the operation of the student unit based on his or her skill level, sport or other activity, and/or physical condition. In an alternative embodiment, the unit may automatically determine the appropriate sensitivity level for the student user, based on previously stored positional information and/or statistically analyzed raw sensor data indicating a history of user movement. In the Pro mode, the user may select whether the unit operates as a pro unit, a student unit, or a standalone unit. While operating as a pro unit, the unit can remotely monitor and/or control one or more student units.

In the Set level 324 mode, the user can manually set the desired sensitivity level for the sensing module 122 (see FIG. 2), or the unit can be made to seek automatically a suitable sensitivity level for the user. In the Calibrate 328 mode, the local or remote user can perform a calibration routine to set the reference orientation of the unit.

Specifically, the calibration routine allows the user to establish a reference or “balanced” position so that any deviations (e.g., tilts) of the user's body from the reference position can be accurately detected and/or measured by the unit. For example, the student may mount the unit on an appropriate area of his or her body or clothing, and then stand in a relaxed position looking straight ahead to establish his or her balanced position. Next, the student depresses the on/off/cal pushbutton for a short time to enter the Calibrate 328 mode. As a result, if the student did not place the unit in an exact horizontal position on his or her body, or if the user is not standing exactly upright, then the unit performs the calibration routine to compensate for such errors, thereby assuring that subsequent measurements of tilt relative to the balanced position are accurate.

In the preferred embodiment, after the student depresses the on/off/cal pushbutton to enter the Calibrate 328 mode, the unit provides audible and/or visible feedback to prompt the student to perform a specific movement of his or her body. For example, the unit may prompt the student to make a forward movement, a backward movement, or a movement to one side. In this way, the unit can determine the orientation of a forward direction, a backward direction, or a left/right direction relative to the location of the unit on the student's body. As a result, if, for example, one tennis player positions the unit just behind his or her right ear while another tennis player chooses to position the unit just behind his or her left ear, then the respective units perform the calibration routine to assure that when the students nod their heads, the units correctly detect the heads tilting in the forward (and not the backward) direction.

In the event the user accesses the programming modes 314, the user may simultaneously depress the Mode pushbutton and the Down or Up pushbutton to cycle through and to select the following programming modes: Set volume 330, Set directions 332, Set response 334, Set voice 336, and Set channel 338. In the Set volume 330 mode, the user may set the volume level (e.g., off/low/medium/high) of the speaker, the ear plug, or the headphones. In the Set directions 332 mode, the user may enable/disable one or more tilt/rotation directions (left, right, front, back, clockwise, counter clockwise) of the sensing module 122 (see FIG. 2). In the Set response 334 mode, the user may choose from among the plurality of data files stored in the data memory 114 (see FIG. 2) to obtain the most appropriate verbal feedback based on the user's current sport or activity. In the Set voice 336 mode, the user may select the type of audible feedback to be provided by the unit, e.g., spoken word/phrases or tones. In the Set channel 338 mode, the user may select the appropriate RF channels for communicating between the pro unit and selected ones of the student units.

The embodiments disclosed herein will be better understood with reference to the following illustrative example and FIG. 1. In this example, a number of student users such as tennis players mount the respective student units 104.1-104.n on their headbands. Each one of the student units 104.1-104.n is placed in the student mode of operation to allow a professional such as a tennis pro to monitor and control the respective unit. Next, each tennis player actuates the on/off/cal pushbutton of his or her unit to perform the calibration routine. Alternatively, the tennis pro calibrates each student unit remotely via the RF channels 108.1-108.n using the pro unit 102. Next, the tennis players start playing tennis, and the tennis pro monitors the angular and/or rotational position information generated by the respective student units via the RF channels 108.1-108.n using the pro unit 102. For example, the tennis pro may select one or more RF channels 108.1-108.n to monitor the positional information generated by one or more student units 104.1-104.n. At this time, the audible feedback provided by the student units 104.1-104.n may be disabled so that the tennis players are not unduly distracted by the feedback. The tennis pro then adjusts the sensitivity setting of each student unit 104.1-104.n so that the respective unit provides audible feedback to the tennis player only when he or she performs a motion incorrectly. The sensitivity settings are determined by the tennis pro to provide the appropriate feedback to the tennis player to correct a specific motion of interest, e.g., a motion performed while serving a tennis ball. After the sensitivity settings of all of the student units 104.1-104.n have been remotely determined and set by the tennis pro, the pro remotely enables the audio feedback capability of the student units 104.1-104.n to allow the tennis players to hear the audible feedback. By determining the appropriate sensitivity setting of each student unit 104.1-104.n individually, the tennis pro can create a learning environment that best suits each one of the student tennis players.

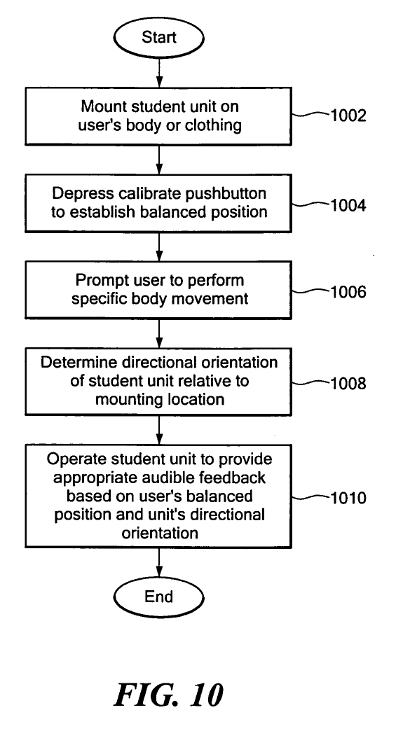

A method of calibrating one of the student units included in the presently disclosed body position monitoring system is illustrated by reference to FIG. 10. As depicted in step 1002, a student user mounts the student unit on an appropriate area of his or her body or clothing. Next, the student depresses the on/off/cal pushbutton of the student unit, as depicted in step 1004, to enter the Calibrate mode while standing upright and looking straight ahead, thereby performing a calibration routine to establish his or her balanced position. The student unit then provides audible and/or visible feedback, as depicted in step 1006, to prompt the student to perform a specific movement of his or her body. For example, in the event the student unit is mounted on the student's headband, the unit may prompt the student user to nod his or her head. In response to the student's nodding head movement, the student unit determines the orientation of a forward direction relative to the location of the unit on the student's headband, as depicted in step 1008. The calibrated student unit is then operated to provide appropriate audible feedback to the student during use, as depicted in step 1010, based on the balanced position of the student and the directional orientation of the unit.

Having described the above illustrative embodiments, other alternative embodiments or variations may be made. For example, it was described that each student unit 104.1-104.n (see FIG. 1) is mountable on or otherwise attachable to a selected body part of the user (e.g., head or chest) or on a selected article of the user's clothing (e.g., hat or jersey). It is understood, however, that in alternative embodiments, the student unit may be configured to be incorporated into the user's eyeglasses, sunglasses, hat, headband, or any other suitable headgear or sportswear, and/or any suitable article of the user's clothing.

In addition, it was described that the student unit may be configured to vibrate in response to the sensed body position. In this configuration, multiple vibration output elements may be mounted on or attached to the user's body, and the location of a vibration output element on the user's body may indicate the direction of tilt. For example, four vibration output elements providing vibrational feedback to the user may be driven from one student unit and mounted on, attached to, or incorporated into the user's headband to indicate tilt in the front, back, right, and left directions.

In addition, those of ordinary skill in the art should appreciate that the functions of the voice processor 124 (see FIG. 2) may be software-driven and executable out of the memory 114 by the microprocessor 112. In alternative embodiments, the functions of the voice processor 124 may be embodied in whole or in part using hardware components such as application specific integrated circuits or other hardware components or devices, or a combination of hardware components and software.

Those of ordinary skill in the art will further appreciate that variations to and modification of the above-described adjustable training system for athletics and physical rehabilitation including student unit and remote unit communicable therewith may be made without departing from the inventive concepts disclosed herein. Accordingly, the invention should not be viewed as limited except as by the scope and spirit of the appended claims.

1. An apparatus for monitoring the position of a body part of a user, the apparatus being attachable to the user's body part, comprising:
a sensor configured to sense an angular rotation of the body part around at least one axis, and to provide data representative of the sensed angular rotation;
a memory operative to store data representative of a plurality of spoken words or phrases;
a first processor operative to compare the sensed angular rotation to at least one predetermined threshold, and, in the event the angular rotation exceeds the predetermined threshold, to access word or phrase data signaling the sensed angular rotation from the memory;
a voice processor operative to convert the accessed word or phrase data to a corresponding voice signal; and
an audio sub-system configured to receive the voice signal from the voice processor, and to audibly produce the spoken word or phrase corresponding to the voice signal, thereby providing verbal feedback signaling the sensed angular rotation to the user.

2. The apparatus of claim 1 wherein the sensor is configured to sense a magnitude of angular displacement.

3. The apparatus of claim 1 wherein the sensor is configured to sense a magnitude of rotational displacement.

4. The apparatus of claim 1 wherein the voice signal corresponding to the accessed word or phrase is representative of the voice of the user.

5. The apparatus of claim 1 wherein the voice signal corresponding to the accessed word or phrase is representative of the voice of a predetermined individual other than the user.

6. The apparatus of claim 1 wherein the voice signal corresponding to the accessed word or phrase is representative of the voice of a predetermined individual selectable by the user.

7. The apparatus of claim 1 wherein the memory is operative to store data representative of a plurality of spoken words or phrases in a language selectable by the user.

8. The apparatus of claim 7 wherein the spoken words or phrases are stored in the memory in a plurality of different languages.

9. The apparatus of claim 1 wherein the first processor is communicably coupleable to a data communications network.

10. The apparatus of claim 9 wherein the data communications network comprises a local area network.

11. The apparatus of claim 9 wherein the data communications network comprises a wide area network.

12. The apparatus of claim 9 wherein the first processor is operative to receive the data representing the plurality of spoken words or phrases over the network for subsequent storage in the memory.

13. The apparatus of claim 9 wherein the first processor is operative to access the data representing the plurality of spoken words or phrases from the memory, and to transmit the word or phrase data over the network.

14. The apparatus of claim 1 wherein the memory is further operative to store a history of user movement, and wherein the first processor is further operative to determine the at least one threshold based on the stored history of user movement.

15. A method of monitoring the position of a body part of a user, comprising the steps of:
sensing an angular rotation of the body part around at least one axis by a sensor attachable to the user's body part;
storing data representative of a plurality of spoken words or phrases in a memory;
comparing the sensed angular rotation to at least one predetermined threshold by a first processor;
in the event the angular rotation exceeds the predetermined threshold, accessing word or phrase data signaling the sensed angular rotation from the memory by the first processor;
converting the accessed word or phrase data to a corresponding voice signal by a voice processor; and
audibly producing the spoken word or phrase corresponding to the voice signal by an audio sub-system, thereby providing verbal feedback signaling the sensed angular rotation to the user.

16. The method of claim 15 wherein the sensing step includes sensing a magnitude of angular displacement.

17. The method of claim 15 wherein the sensing step includes sensing a magnitude of rotational displacement.

18. The method of claim 15 wherein the converting step includes converting the accessed word or phrase data to a corresponding voice signal representative of the voice of the user.

19. The method of claim 15 wherein the converting step includes converting the accessed word or phrase data to a corresponding voice signal representative of the voice of a predetermined individual other than the user.

20. The method of claim 15 wherein the converting step includes converting the accessed word or phrase data to a corresponding voice signal representative of the voice of a predetermined individual selectable by the user.

21. The method of claim 15 wherein the storing step includes storing data representative of a plurality of spoken words or phrases in a language selectable by the user.

22. The method of claim 21 wherein the storing step includes storing data representative of a plurality of spoken words or phrases in a plurality of different languages.

23. The method of claim 15 further including the step of communicably coupling the first processor to a data communications network, the network being one of a local area network and a wide area network.

24. The method of claim 23 further including the step of receiving the data representing the plurality of spoken words or phrases over the network.

25. The method of claim 23 further including the step of transmitting the data representing the plurality of spoken words or phrases over the network.

26. The method of claim 15 further including the steps of storing a history of user movement in the memory, and determining the at least one threshold based on the stored history of user movement by the first processor.

27. An apparatus for monitoring the position of a body part of a user, the apparatus being attachable to the user's body part, comprising:
a sensor configured to sense an angular rotation of the body part around at least one axis, and to provide data representative of the sensed angular rotation,
wherein the sensed angular rotation results from a motion of the user's body part, the frequency of the motion being within a predetermined frequency range; and
a processor operative to filter the sensed angular rotation data to remove frequencies outside the predetermined frequency range, and to provide an output signaling the sensed angular rotation based at least on a magnitude of the filtered angular rotation data.

28. The apparatus of claim 27 wherein the processor is operative to perform low pass filtering of the sensed angular rotation data to remove frequencies above the predetermined frequency range.

29. The apparatus of claim 27 wherein the processor is operative to perform high pass filtering of the sensed angular rotation data to remove frequencies below the predetermined frequency range.

30. The apparatus of claim 27 wherein the processor is operative to perform band-pass filtering of the sensed angular rotation data to remove frequencies above and below the predetermined frequency range.

31. The apparatus of claim 27 wherein the processor is operative to perform a selected type of filtering of the sensed angular rotation data based on an activity of the user.

32. The apparatus of claim 27 wherein the sensed angular rotation data includes data representative of a position of the user's body part, and wherein the processor is further operative to measure a length of time the user's body part is positioned at a particular position, and to provide an output signaling the sensed angular rotation based at least on the measured length of time.

33. A method of monitoring the position of a body part of a user, comprising the steps of:
sensing an angular rotation of the body part around at least one axis by a sensor attachable to the user's body part;
providing data representative of the sensed angular rotation by the sensor, wherein the sensed angular rotation results from a motion of the user's body part, the frequency of the motion being within a predetermined frequency range;
filtering the sensed angular rotation data to remove frequencies outside the predetermined frequency range by a processor; and
providing an output signaling the sensed angular rotation based at least on a magnitude of the filtered angular rotation data by the processor.

34. The method of claim 33 wherein the filtering step includes performing low pass filtering of the sensed angular rotation data to remove frequencies above the predetermined frequency range.

35. The method of claim 33 wherein the filtering step includes performing high pass filtering of the sensed angular rotation data to remove frequencies below the predetermined frequency range.

36. The method of claim 33 wherein the filtering step includes performing band-pass filtering of the sensed angular rotation data to remove frequencies above and below the predetermined frequency range.

37. The method of claim 33 wherein the filtering step includes performing a selected type of filtering of the sensed angular rotation data based on an activity of the user.

38. The method of claim 33 wherein the sensed angular rotation data includes data representative of a position of the user's body part, and further including the steps of measuring a length of time the user's body part is positioned at a particular position by the processor, and providing an output signaling the sensed angular rotation based at least on the measured length of time by the processor.

39. A system for monitoring the position of a body part of a user, comprising:
at least one local unit attachable to the user's body part, the local unit being operative to sense an angular rotation of the body part around at least one axis, and, in the event the angular rotation exceeds a first threshold level, to provide an output signaling the sensed angular rotation; and
at least one remote unit operative to monitor the signaling output provided by the local unit.

40. The system of claim 39 wherein the at least one remote unit is further operative to adjust the first threshold level of the local unit based at least in part on the monitored signaling output.

41. The system of claim 39 wherein the local unit is operative to provide data representative of the sensed angular rotation, and to perform a selectable type of filtering of the sensed angular rotation data, and the remote unit is operative to select the type of filtering performed by the local unit.

42. The system of claim 41 wherein the type of filtering is one of a frequency domain filtering type and a time domain filtering type.

43. The system of claim 39 wherein the local unit is operative, in the event the angular rotation exceeds the first threshold level, to access word or phrase data signaling the sensed angular rotation from a memory, to convert the accessed word or phrase data to a corresponding voice signal, and to audibly produce the output signaling the sensed angular rotation as the spoken word or phrase corresponding to the voice signal, thereby providing verbal feedback signaling the sensed angular rotation to the user.

44. The system of claim 43 wherein the remote unit is operative to set an adjustable operational parameter of the local unit, and the local unit is operative to audibly produce or not to produce the spoken word or phrase based on the setting of the adjustable operational parameter.

45. The system of claim 39 wherein the local unit and the remote unit comprise respective wireless communications interfaces, and wherein the remote unit is operative to monitor the signaling output provided by the local unit via the respective wireless communications interfaces.

46. The system of claim 45 wherein the remote unit is further operative to set the first threshold level of the local unit via the respective wireless communications interfaces.

47. A method of monitoring the position of a body part of a user, comprising the steps of:
providing at least one local unit, the local unit being attachable to the user's body part;
sensing an angular rotation of the body part around at least one axis by the local unit;
in the event the angular rotation exceeds a first threshold level, providing an output signaling the sensed angular rotation by the local unit; and
monitoring the signaling output provided by the local unit by at least one remote unit.

48. The method of claim 47 further including the step of adjusting the first threshold level of the local unit based at least in part on the monitored signaling output by the remote unit.

49. The method of claim 47 further including the steps of providing data representative of the sensed angular rotation by the local unit, performing a selectable type of filtering of the sensed angular rotation data by the local unit, and selecting the type of filtering to be performed on the angular rotation data by the remote unit.

50. The method of claim 49 wherein the type of filtering is one of a frequency domain filtering type and a time domain filtering type.

51. The method of claim 47 further including the steps of accessing word or phrase data signaling the sensed angular rotation from a memory by the local unit in the event the angular rotation exceeds the first threshold level, converting the accessed word or phrase data to a corresponding voice signal by the local unit, and audibly producing the signaling output as the spoken word or phrase corresponding to the voice signal, thereby providing verbal feedback signaling the sensed angular rotation to the user.

52. The method of claim 51 further including the steps of setting an adjustable operational parameter of the local unit by the remote unit, and selectively producing the spoken word or phrase based on the setting of the adjustable operational parameter by the local unit.

53. The method of claim 47 further including the step of monitoring the signaling output by the remote unit via a wireless communications interface.

54. The method of claim 53 further including the step of setting an adjustable operational parameter of the local unit by the remote unit via the wireless communications interface.

55. An apparatus for monitoring the position of a body part of a user, the apparatus being attachable to the user's body part, comprising:
a sensor operative to sense an angular rotation of the body part around at least one axis, and to provide data representative of the sensed angular rotation; and
a processor operative to provide a first output signaling the user to rotate the body part in a predetermined direction relative to the at least one axis to establish a directional orientation of the sensor, and to provide a second output signaling the sensed angular rotation based at least in part on the directional orientation of the sensor.

56. A method of monitoring the position of a body part of a user, comprising the steps of:
sensing an angular rotation of the body part around at least one axis by a sensor, the sensor being attachable to the user's body part;
providing data representative of the sensed angular rotation by the sensor;
providing a first output signaling the user to rotate the body part in a predetermined direction relative to the at least one axis by a processor, thereby establishing a directional orientation of the sensor; and
providing a second output signaling the sensed angular rotation based at least in part on the directional orientation of the sensor by the processor.
